(19) United States
(12) Patent Application Publication
(10) Pub. No.: US 2009/0112583 A1
(43) Pub. Date: Apr. 30, 2009

(54) Language Processing System, Language Processing Method and Program

(76) Inventors: Yousuke Sakao, Tokyo (JP); Kenji Satoh, Tokyo (JP); Takahiro Ikeda, Tokyo (JP); Yoshihiro Ikeda, Chiba (JP); Satoshi Nakazawa, Tokyo (JP)

Correspondence Address: FOLEY AND LARDNER LLP;SUITE 500, 3000 K STREET NW, WASHINGTON, DC, 20007, US

(21) Appl. No.: 12/224,785

(22) PCT Filed: Feb. 22, 2007
(86) PCT No.: PCT/JP2007/053274

§ 371 Date: Sep. 5, 2008

(30) Foreign Application Priority Data
Mar. 7, 2006 (JP) 2006-061384

(51) Int. Cl. G10L 15/00; G06F 17/00

(52) U.S. Cl. 704/231; 707/104.1; 704/E15.001

(57) ABSTRACT

A language processing system, method, and program to automatically in time obtain text analysis results. The system comprises a plurality of text analysis units, each performing a different type of text analysis processing, an analysis order control means controlling order of analysis of text by each of the text analysis means, and an additional processing execution means receiving and executing additional processing for the text analysis results from each of the text analysis means, from a user. At a stage which a text analysis result by any one of said text analysis units is outputted and said additional processing execution unit operates, said analysis order control unit performs control to start text analysis processing for other text analysis means.

### TECHNICAL FIELD

The present invention relates to a language processing system, a language processing method and a program for structuring, as text structure, and analyzing electronic text stored in a computer.

### BACKGROUND ART

An example of a conventional language processing system in which text analysis level can be selected according to conditions is described in Patent Document 1. In a conventional text correction device shown in FIG. 15, an analysis means in which it is possible to compose text corresponding to several analysis levels using a correction dictionary, a level setting means for setting a selected analysis level for the analysis means, and a control means for controlling the analysis means so as to correct according to the set analysis level and output corrected text to a display means, are provided, and it is possible to change level of detail of analysis.

Other than this, a retrieval system described in Non-Patent Document 1 may be cited, in which simple analysis and detailed analysis are combined. In this conventional retrieval system shown in FIG. 16, firstly text to be analyzed is focused upon by primary retrieval according to independent-word/function-word included in a query obtained by the simple analysis, and after that, secondary retrieval according to dependency structure obtained by detailed analysis is performed.

### [Patent Document 1]

JP Patent Kokai Publication No. JP-A-5-298302

### [Non-Patent Document 1]

Hyodo, Y., Kawada, M., Ying, J., and Ikeda, T.: Building a Large Corpus with Skeltal Syntactic Structure and its Application to Similar Sentence Retrieval System, Shizen-Gengo-Shori (Natural Language Processing), Vol. 3, No. 2, pp 73-88, 1996.

### DISCLOSURE OF THE INVENTION

### Problems to be Solved by the Invention

The disclosures of the abovementioned documents are incorporated herein by reference thereto.

In a device using text analysis such as a general text mining device or the like, when high speed text analysis processing is desired, only a result of low accuracy is obtained, and when high accuracy text analysis processing is desired, processing takes time. As a result, in cases in which a user is not satisfied on confirming output by a high speed simple analysis, it is necessary to repeat text analysis by detailed analysis.

In the text correction device described in Patent Document 1, from this type of viewpoint it is possible to change analysis level according to conditions, but with the abovementioned conventional technology, the following problems remain.

A first problem is that with the conventional technology a user must judge a necessary analysis level in advance. That is, in such cases as where, after performing a high speed analysis on text, it was desired to obtain a detailed text analysis result, the user must once again explicitly instruct carrying out of a detailed analysis.

A second problem is that with the conventional technology there are cases in which overall analysis processing takes a long time. Simply stated, after performing the high speed analysis on text as described above, in cases in which detailed analysis is necessary after the user has performed interaction (system interaction) such as output and aggregation tasks thereof, compared to cases in which high speed analysis and detailed analysis are performed consecutively, extra time is expended in the abovementioned interaction (system interaction).

The present invention has been made in light of the abovementioned circumstances, and it is an object thereof to provide a language processing system, a language processing method, and a program, in which it is possible to automatically obtain text analysis results by different text analysis processing modes without explicit instruction from a user, and it is possible to obtain text analysis results in a short time even in cases in which interaction takes place.

### Means to Solve the Problems

According to a first aspect of the present invention, a language processor is provided that including a plurality of text analysis units, each performing a different type of text analysis processing; an analysis order control unit for controlling order of analysis of a plurality of input texts by each of the text analysis units; and an additional processing execution unit for taking text analysis results of the plurality of input texts from the text analysis units, and for receiving and executing additional processing from a user, with regard to the text analysis results; wherein at a stage at which a text analysis result by any one of the text analysis units is outputted and the additional processing execution unit operates, the analysis order control unit performs control to start text analysis processing for other text analysis means.

Furthermore, according to a second aspect of the invention, a language processing method is provided for a language processor for analyzing text, the processor including a plurality of text analysis units, each performing a different type of text analysis processing; an analysis order control unit for controlling order of analysis of a plurality of input texts by each of the text analysis units; and an additional processing execution unit for taking text analysis results of the plurality of input texts from the text analysis units, and for receiving and executing additional processing from a user, with regard to the text analysis results; wherein the method comprises a step in which the additional processing execution unit starts dialogue with the user, with regard to additional processing for a text analysis result outputted by any one of the text analysis units; and a step in which the analysis order control unit starts text analysis processing by another text analysis unit, in the background to dialogue processing between the user and the additional processing execution unit.

Furthermore, according to a third aspect of the invention, a language processing program is provided for controlling a computer and analyzing text, the computer including: a plurality of text analysis units, each performing a different type of text analysis processing; an analysis order control unit for controlling order of analysis of a plurality of input texts by each of the text analysis units; and an additional processing execution unit for taking text analysis results of the plurality of input texts from the text analysis units, and for receiving and executing additional processing from a user, with regard to said text analysis results; the program causing the computer to execute a process of starting dialogue with a user, with regard to additional processing for a text analysis result outputted by any one of the text analysis units; and a process of starting text analysis processing in another text analysis unit, in the background to dialogue processing between the user and the additional processing execution unit.

### MERITORIOUS EFFECTS OF THE INVENTION

A first effect of the present invention is that, after performing high speed analysis on text, it is possible to perform detailed analysis automatically without a user's explicit instruction. A reason for this is that detailed analysis is automatically performed after simple analysis ends, by an instruction of an analysis order control unit. Furthermore, by having a simple text analysis unit and a detailed text analysis unit in which processing is heavy not operate in parallel, text analysis by the simple text analysis unit is not delayed. Furthermore, since an additional processing execution unit used in the present invention operates based on input, waiting time for this input occurs, and by making a detailed text analysis unit operate in this input waiting time, it is possible to execute the detailed text analysis unit efficiently in the background.

### BRIEF DESCRIPTION OF THE DRAWINGS

FIG. 1 is a block diagram showing a configuration of a language processing system according to a first exemplary embodiment of the present invention.

FIG. 2 is a flow diagram for describing analysis output operations in the language processing system according to the first exemplary embodiment of the invention.

FIG. 3 is a flow diagram for describing output operations in the language processing system according to the first exemplary embodiment of the invention.

FIG. 4 is a diagram expressing execution flow for each process in the language processing system according to the first exemplary embodiment of the invention.

FIG. 5 is a diagram showing a text set used in the first and a second exemplary embodiment of the invention.

FIG. 6 is a diagram describing analysis processing of the text set shown in FIG. 5.

FIG. 7 is a diagram describing analysis processing of the text set shown in FIG. 5.

FIG. 8 is a diagram describing analysis processing of the text set shown in FIG. 5.

FIG. 9 is a diagram describing analysis processing of the text set shown in FIG. 5.

FIG. 10 is a diagram describing analysis processing of the text set shown in FIG. 5.

FIG. 11 is a diagram describing analysis processing of the text set shown in FIG. 5.

FIG. 12 is a diagram describing analysis processing of the text set shown in FIG. 5.

FIG. 13 is a diagram describing analysis processing of the text set shown in FIG. 5.

FIG. 14 is a diagram describing analysis processing of the text set shown in FIG. 5.

FIG. 15 is a block diagram showing a configuration of a conventional text correction device.

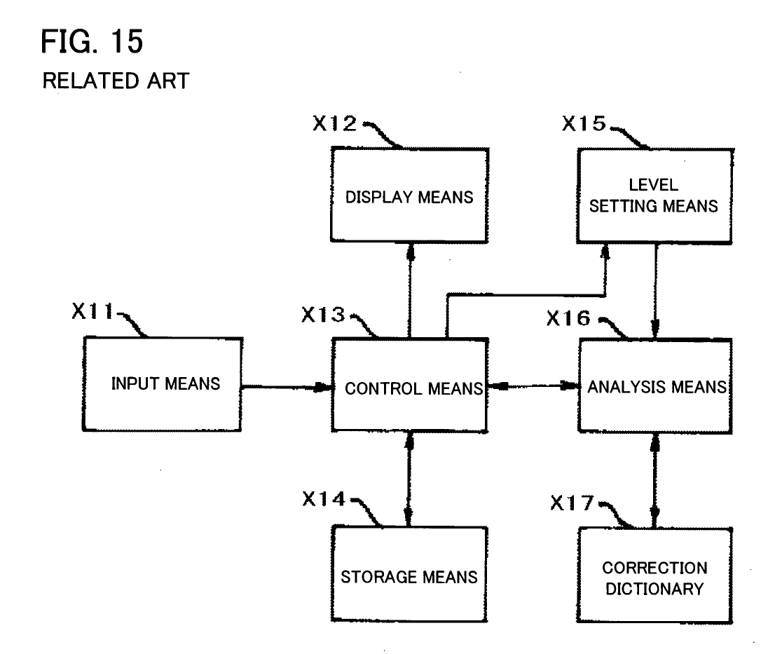

FIG. 16 is a diagram showing a configuration of a conventional retrieval system.

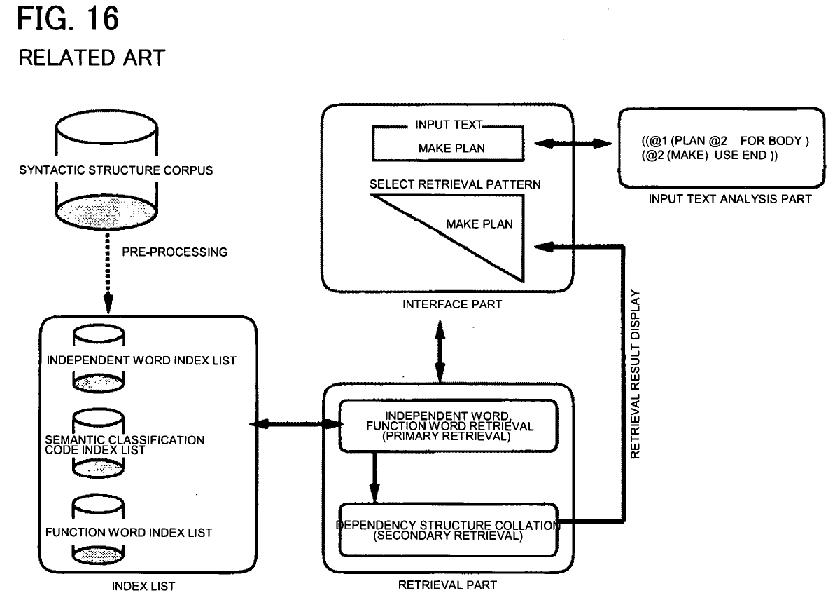

### EXPLANATIONS OF SIGNS

1 storage device
2 data processing device
3 output device
4 input device
11 text DB (text database)
21 simple text analysis unit
22 detailed text analysis unit
23 analysis order control unit
24 analysis result holding unit
25 output generation unit
26 additional processing execution unit

### PREFERRED MODES FOR CARRYING OUT THE INVENTION

Next, a detailed description will be given concerning preferred modes for carrying out the present invention, making referring to the drawings.

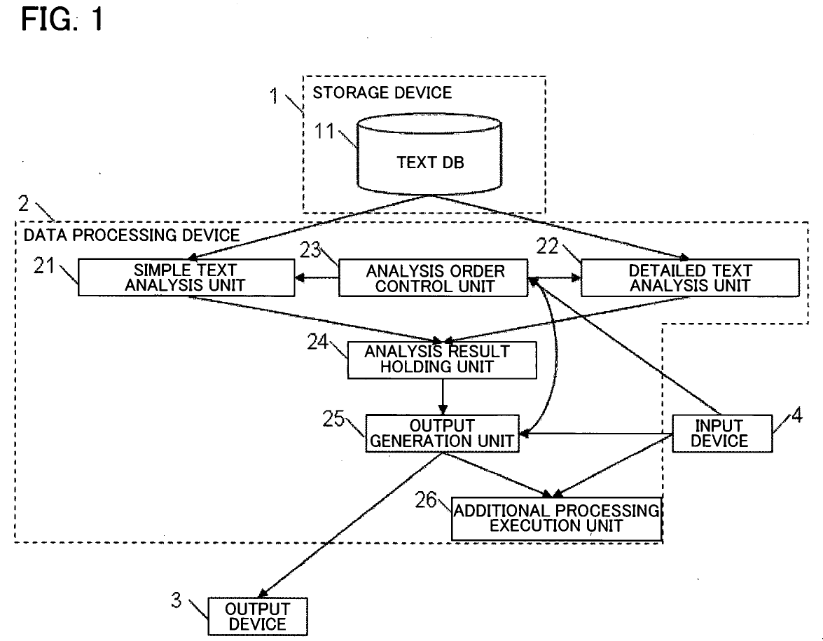

Referring to FIG. 1, a language processing system according to a first exemplary embodiment of the present invention is composed of a storage device 1 for storing information, a data processing device 2 that operates by program control, an output device 3 for displaying a result of language processing to a user, and an input device 4 for receiving input from the user.

The storage device 1 stores a set of texts that are targets of language processing.

The data processing device 2 includes a simple text analysis unit 21, a detailed text analysis unit 22, an analysis order control unit 23, an analysis result holding unit 24, an output generation unit 25, and an additional processing execution unit 26.

The simple text analysis unit 21 and the detailed text analysis unit 22 analyze text and output text structures (of skeletal syntactic structure). Here, the text structures represent structure of a text by a graph structure or the like. In the simple text analysis unit 21 a text analysis method is used in which it is possible to perform analysis at high speed even if accuracy is low. In the detailed text analysis unit 22, a text analysis method is used in which it is possible to perform high accuracy analysis even if speed is low.

The output generation unit 25 is a unit for taking, as input, text structures, as in an application for text mining which extracts frequently appearing part structures from a set of text structures, to be presented to a user as characteristic (or feature) structures, and executing processing which generates output directed to a user.

The additional processing execution unit 26 is a unit for receiving from the user, as input, part of output presented by the output generation unit 25 through the output device 3, and performing the abovementioned various types of additional processing, as in a program for aggregating and analyzing characteristic structures outputted by an application for text mining, or in text mining re-processing which changes conditions of inputted text structures or the like.

Below, “interaction with output by a user” refers to confirmation tasks and aggregation tasks by the user, for output by the output generation unit 25, and to manual input to the additional processing execution unit 26.

These various processing means respectively operate generally as follows.

The simple text analysis unit 21 reads a text set from text DB 11, analyzes each text in the set at high speed to obtain a result set of the text analysis, to be stored in the analysis result holding unit 24.

The output generation unit 25 generates user-directed output from text structures by the simple text analysis means 21 stored in the analysis result holding unit 24, to be displayed on the output device 3. Order of text analysis by the simple text analysis unit 21 and the detailed text analysis unit 22 is controlled by the analysis order control means 23.

The user at this point in time uses the output device 3 and the input device 4, to send part of the output to the additional processing execution means 26 and the like, and is able to perform interaction with the output.

As described above, even while the user is performing interaction with the output, by control of the analysis order by the analysis order control means 23, the detailed text analysis means 22 reads the text set from text the DB1, analyzes each text in the set, obtains text structure of each text, and performs substitution of text structure by the simple text analysis means 21 stored in the analysis result holding means 24. In this detailed text analysis processing, a simple analysis result by the simple text analysis means 21 may be reused.

Furthermore, the order of the detailed analysis in the abovementioned detailed text analysis processing is changed as appropriate by the analysis order control means 23, based on level of importance computed by the output generation means 25, or interaction with the user.

As a method of determining order of text that is a target of detailed analysis determined by the abovementioned analysis order control means 23, the following may be cited.

(A1) Order that is randomly set irrespective of sequence in which each text is stored in the text set or stored order, and in particular, order that does not consider text characteristics or the like. Such cases, since there is no dependency on specific conditions, as in (A2) to (A4) below, are characterized in that output does not easily change rapidly.

(A2) Order based on information added to inputted text, such as order based on length of text, order based on attributes associated with each text in the text DB 11, and the like. This method can only be used in cases in which an attribute value such as whether or not there is a positive example (text selected by the user to be analyzed by text mining) in the text mining, or text length, is assigned to each text in the text set, and it is possible to perform detailed analysis in an order in which text having a specific attribute value is given priority.

(A3) Order based on weight of text obtained when the output generation unit 25 generates output, of number of characteristic structures and the like included in the text in text mining which abstracts characteristic structures frequently appearing in the set of text structures. This method can be used in cases in which the output generation unit 25, which generates output from the text structures and also computes weight (importance) of the text, is provided, and it is possible to perform detailed analysis with priority given to text judged as important by the output generation unit 25.

(A4) Order based on weight (importance) of text obtained by interaction with the user, such as whether or not the text includes a characteristic structure inputted to the additional processing execution unit 26 by the user. This method can be used only in cases in which an aggregation means or the like is provided as an additional output means, and interaction between the user and the output is possible, and it is possible to perform detailed analysis with priority given to text that is a source of output the user is focusing on, or text having a characteristic the user is focusing on. As another example of this type of method of determining order, an order may be cited that is based on the number of characteristic structures inputted by the user to the additional processing execution unit 26, that are included in the text.

The output generation unit 25 reflects updating of text structures held in the analysis result holding unit 24 as a result of the abovementioned detailed analysis, performs updating of user-directed output, and sends the updated output to the output device 3, to be displayed to the user. At this juncture, at predetermined timing, the text structure by the simple text analysis unit 21 can be sequentially substituted into the text structure by the detailed text analysis unit 22, to be presented again to the user after re-composing the output. For timing at which updated output is presented again to the user, the following may be cited, for example.

(B1) Updating is done whenever detailed analysis of 1 text is ended. In such cases, it is possible to always automatically obtain the latest output.

(B2) Updating is done whenever detailed analysis of a decided number of texts is ended. For example, it is possible to obtain the latest output whenever updating of a determined amount is done.

(B3) Updating is done every fixed time period. In such cases, it is possible to obtain the latest output every fixed period of time.

(B4) Updating is done at timing at which an instruction of result updating is received from the user. In such cases, it is possible to update the output at the user's preferred timing.

(B5) Updating is done after the detailed analysis of the entire text set is ended. In such cases, output by the simple analysis and output by the detailed analysis can be completely separated to be handled.

Furthermore, for output based on the simple analysis result the user has inputted to the additional processing execution unit 26, in order to prevent this output result from being inadvertently updated, it is possible to stop this output from being updated at output updating time, or to have the user give confirmation.

Furthermore, in order to prevent output based on the simple analysis result, that the user has referred to, from being inadvertently updated, it is possible to generate output by the detailed analysis result separately to output by the simple analysis result, rather than perform updating of output by substituting the simple analysis result for the detailed analysis result.

By control of analysis order by the analysis order control unit 23, and by having the simple text analysis unit 21 and the detailed text analysis unit 22, in which processing is heavy, not operate in parallel, prevention of delay of text analysis by the simple text analysis unit 21 is also realized. In particular, in cases in which the user can obtain a satisfactory result by additional processing by the additional processing execution unit 26 using output by the simple text analysis unit 21, since the user can terminate subsequent processing, it is important that output by the simple text analysis unit 21 is not delayed.

Furthermore, in the present exemplary embodiment, since the additional processing execution unit 26 operates based on input from the user, waiting time for this input occurs. By control of the analysis order by the analysis order control unit 23, by making the detailed text analysis unit 22 operate in this input waiting time, it is possible to make the detailed text analysis unit 22 execute efficiently in the background.

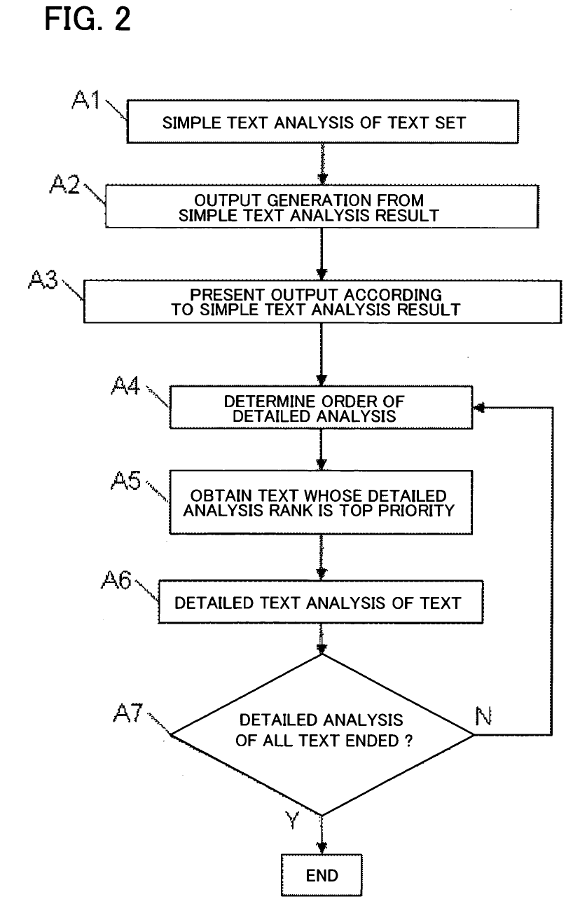

Continuing, a detailed description is given concerning operations of the language processing system according to the present exemplary embodiment, making reference to the drawings. First, referring to FIG. 2, a description is given concerning flow of operations of text analysis in the language processing system according to the present exemplary embodiment.

First, the simple text analysis unit 21 reads the text set from the text DB 11, and analyzes each text in the set at high speed to obtain a result set of the text analysis, to be stored in the analysis result holding unit 24 (step A1).

Continuing, the output generation unit 25 generates user-directed output from text structures by the simple text analysis unit 21 stored in the analysis result holding unit 24 (step A2).

The output device 3 displays to the user, the user-directed output generated by the output generation unit 25 from the simple text analysis result (step A3).

Based on the displayed content, even while the user is making interaction with the output, the analysis order control unit 23 determines the order (or text to be analyzed first) of the detailed analysis based on level of importance computed by the output generation unit 25 or content of interaction with the user (step A4).

The detailed text analysis unit 22 reads the text to be analyzed first according to the order determined by the analysis order control unit 23 in step A4, from the text DB 11 (step A5).

The detailed text analysis unit 22 analyzes the text read from the text DB 11, obtains the text structure, which is substituted with the text structure by the simple text analysis unit 21 (step A6).

If analysis of all texts by the detailed text analysis unit 22 is ended, the text analysis is ended (Y in step A7); otherwise control returns to step A4, and determination of analysis order for text not analyzed by the analysis order control unit 23 is performed (N in step A7).

Processing which the additional processing execution unit 26 performs on the output by the interaction of the user and the output, and processing performed in the abovementioned steps A4 to A7 are carried out in parallel. Accordingly, for example, while detailed analysis of text is being performed in step A5 to step A6, in cases in which interaction is performed with the output by the user, the analysis order control unit 23 reflects this result, and the order of the text analysis is revised.

In the flow chart of FIG. 2, a description is given in which the analysis order by the detailed text analysis unit 22 is revised as needed, but the analysis order of all the texts is determined in step A4, and according to this, the detailed text analysis unit 22 may be made to operate. In such cases, in step A7, when it is judged that analysis of all of the texts is not ended (N in step A7), control returns not to step A4 but to step A5.

Clearly, during this time, the analysis order control unit 23 is not prevented from performing updating of order of analysis by the detailed text analysis unit 22.

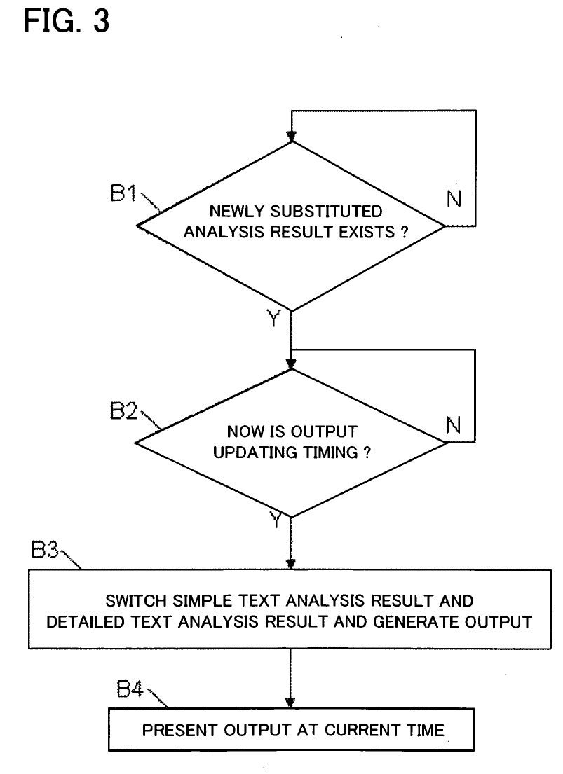

Continuing, referring to FIG. 3, in the language processing system according to the present exemplary embodiment, a description will be given concerning flow of operations in updating content displayed to the user, performed in parallel to the abovementioned text analysis processing.

First, the output generation unit 25 confirms whether or not a text structure newly substituted by the detailed text analysis unit 22 exists in the text structures held in the analysis result holding unit 24 (step B1).

Here, in cases in which a text structure newly substituted by the analysis result holding unit 24 exists (Y in step B1), control proceeds to step B2; and if not, monitoring of the analysis result holding unit 24 continues.

Next, the output generation unit 25 confirms whether or not updating timing (previously described B1 to B5) of output set in advance has arrived (step B2).

Here, in cases in which the updating timing has arrived (Y in step B2), control proceeds to step B3; and if not, arrival of the updating timing is waited for.

The output generation unit 25 reflects updating of the text structures held in the analysis result holding unit 24, performs updating of user-directed output, and sends the updated output to the output device 3 (step B3).

The output device 3 displays the user-directed output updated by the output generation unit 25 to the user (step B4).

Each process of the abovementioned steps B1 to B4 is repeated until reflection, in updating of output, of results of analysis of all texts by the detailed text analysis unit 22, is ended.

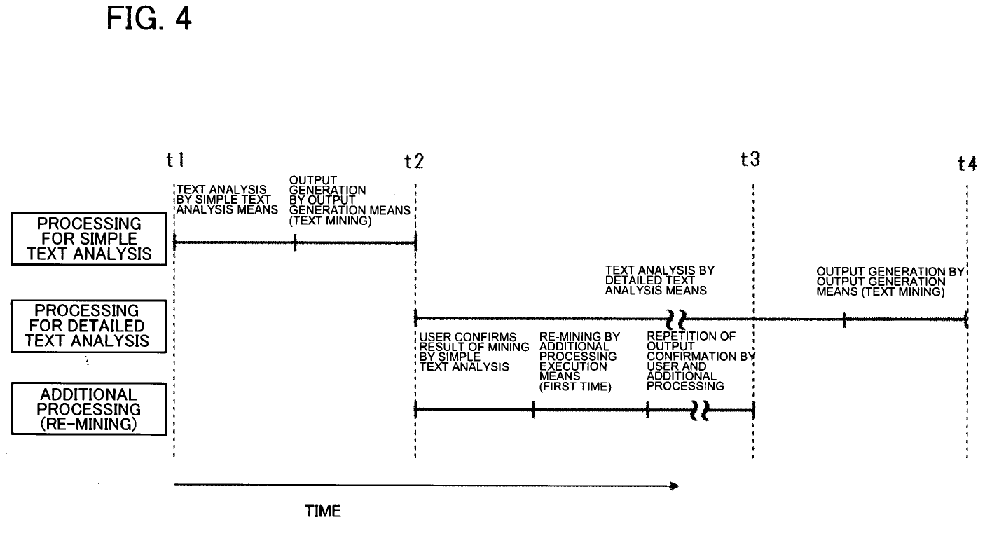

Continuing, an effect of the present exemplary embodiment is described, making reference to FIG. 4 which shows a working example of the language processor according to the present exemplary embodiment when text mining is performed. In the present working example, the output generation unit 25 is a means for performing text mining extracting characteristic expressions from an analysis result of the text set, and the additional processing execution unit 26 is a means for receiving input from the user and changing conditions from the output generation unit 25 to perform text mining again.

Referring to FIG. 4, first, from immediately after starting processing (time t1 in FIG. 4), text analysis by the simple text analysis unit 21 is started, by control of analysis order by the analysis order control unit 23, and then, based on an analysis result thereof, text mining by the output generation unit 25 is performed.

Immediately after output of the text mining result using this simple text analysis result has been performed (time t2 in FIG. 4), the user starts confirmation of the text mining result and performs input to the additional processing execution unit 26 while changing input, conditions, and the like, and the additional processing execution unit 26 executes text mining again based on this input. The user can perform input to repeated additional processing until a satisfactory result is obtained, and can repeat text mining again. Time t3 in FIG. 4 indicates time at which the repeat text mining by the additional processing execution unit 26 is ended.

Furthermore, immediately after output of the text mining result based on the simple text analysis unit 21 has been performed by the output generation unit 25 (time t2 in FIG. 4), text analysis by the detailed text analysis unit 22 is started, by control of analysis order by the analysis order control unit 23, and then, based on an analysis result thereof, text mining by the output generation unit 25 is performed.

Immediately after output of the text mining result using this detailed text analysis result has been performed (time t4 in FIG. 4), the user can start confirmation of this text mining result and perform input to the additional processing execution unit 26 while changing input, conditions, and the like.

Above, as shown in FIG. 4, by control of analysis order by the analysis order control unit 23, with regard to text mining (between time t1 and time t2 in FIG. 4) by the output generation unit 25 using text analysis by the simple text analysis unit 21 and text analysis results thereof, there is no other processing being carried out in parallel. As a result, it is possible to quickly present output from the simple text analysis to the user.

Furthermore, as shown in FIG. 4, by control of order of analysis by the analysis order control unit 23, immediately after output based on the simple text analysis result has been performed (time t2 in FIG. 4), text analysis by the detailed text analysis unit 22 and confirmation of output by the user are started. In this way, by causing the detailed text analysis unit 22 to operate while the additional processing execution unit 26 is waiting for input, time until output by the detailed text analysis is shortened.

As described above, since the present exemplary embodiment is configured such that, by instruction of the analysis order control unit 23, text analysis by the detailed text analysis unit 22 is automatically performed after text analysis by the simple text analysis unit 21 is ended, it is possible to perform a detailed analysis automatically, without the user giving an explicit instruction.

Furthermore, in the present exemplary embodiment, since the text analysis by the detailed text analysis unit 22 is executed in the background, even while the user is performing interaction with output based on text structures by the simple text analysis unit 21, by analysis order control by the analysis order control unit 23, it is possible to obtain output by the detailed analysis quicker than performing detailed analysis sequentially after interaction by the user ends.

Furthermore, in the present exemplary embodiment, since after the simple analysis by the simple text analysis unit 21 is ended, the detailed text analysis unit 22 performs the detailed text analysis based on an order determined by the analysis order control unit by interaction with output by the simple text analysis and the user by an input means or importance level computed by the output generation unit 25 (details thereof are described in an example below), it is possible to obtain at an early stage a detailed analysis result of text which is desired at an early stage due to being focused upon by the user, or the like.

In addition, since the present exemplary embodiment is configured such that a text structure by the simple text analysis unit 21 stored in the analysis result holding unit 24 is replaced by a text structure by the detailed text analysis unit 22, and operation is such that the output generation unit 25 automatically updates output at predetermined timing, it is possible to constantly obtain the latest output without the user explicitly giving an updating instruction.

### EXAMPLE 1

Continuing, a detailed description will be given showing the present invention in a specific example.

A language processing system according to a first example of the present invention is a concretization of the abovementioned first exemplary embodiment of the invention, and is configured by being provided with a personal computer constituting a data processing device 2 of FIG. 1, a magnetic disk storage device constituting a storage device 1, a display device constituting an output device 3, and a keyboard constituting an input device 4.

The personal computer has a simple text analysis unit 21, a detailed text analysis unit 22, an analysis order control unit 23, a central processing unit (CPU) functioning as an output generation unit 25, and a memory functioning as an analysis result holding unit 24. A text set is stored as text DB 11 in the magnetic disk storage device.

Furthermore, the simple text analysis unit 21 in the present example executes text analysis performing dependency parsing as “a certain segment in the text depends on a subsequent segment”, without performing parsing processing.

Furthermore, the detailed text analysis unit 22 in the present example correctly analyzes a dependency structure between segments by parsing, and executes text analysis outputted as a text structure. In general, computational amount of text analysis of the detailed text analysis unit 22 which uses parsing is larger than the text analysis by the simple text analysis unit 21 which does not use parsing.

The output generation unit 25 is a characteristic structure extraction means for extracting, as characteristic structures, part structures appearing two or more times in a text structure set, and sending these to the output device 3 (display device). Timing of updating this output is set such that “updating of output is performed whenever one text structure is sent from the detailed text analysis unit 22”.

Furthermore, in the present example, the analysis order control unit 23 performs control such that the simple text analysis unit 21 and the detailed text analysis unit 22 both analyze according to an order in which the text DB 11 stores the text.

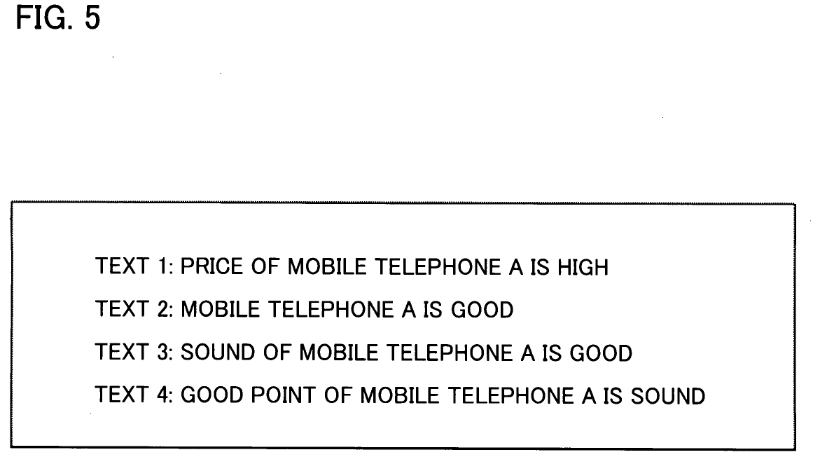

FIG. 5 is an example of a text set stored in the text DB 11. Below, operations thereof are described using text 1 to text 4 of FIG. 5.

First, the simple text analysis unit 21 performs language analysis on each text in the text set in the text DB 11 shown in FIG. 5, and obtains text structure of each text, to be sent to the analysis result holding unit 24 (step A1 in FIG. 2).

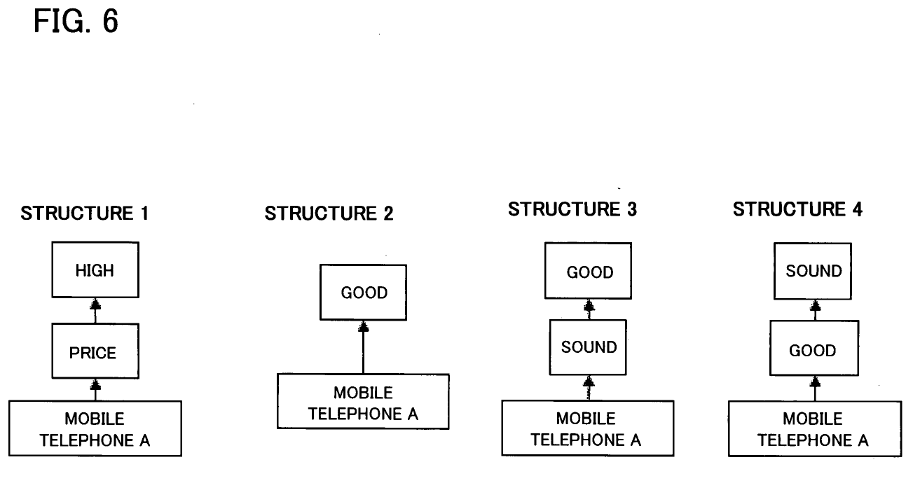

FIG. 6 shows text structures stored in the analysis result holding unit 24 at this time. The text structure of text 1 of FIG. 5 corresponds to structure 1 of FIG. 6, the text structure of text 2 of FIG. 5 corresponds to structure 2 of FIG. 6, the text structure of text 3 of FIG. 5 corresponds to structure 3 of FIG. 6, and the text structure of text 4 of FIG. 5 corresponds to structure 4 of FIG. 6, respectively.

The output generation unit 25 extracts, as characteristic structures, part structures appearing two or more times in the set of text structures according to the simple text analysis unit 21 shown in FIG. 6, and stored in the analysis result holding unit 24, to be sent to the output device 3 (step A2 in FIG. 2).

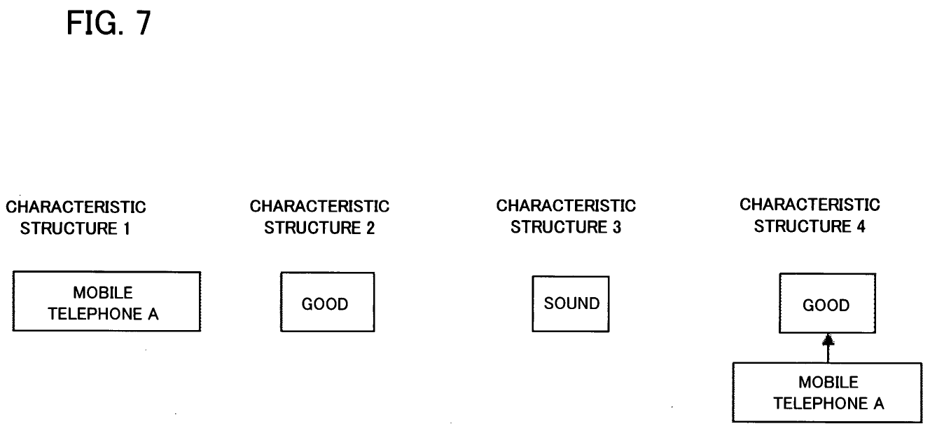

FIG. 7 shows characteristic structures extracted from the text structure of FIG. 6. A characteristic structure 1 “mobile telephone A” of FIG. 7 appears once in each of structures 1 to 4 of FIG. 6, a characteristic structure 2 “good” of FIG. 7 appears once in each of structures 2 to 4 of FIG. 6, a characteristic structure 3 “sound” of FIG. 7 appears once in each of structures 3 and 4 of FIG. 6, and a characteristic structure 4 “mobile telephone A→good” of FIG. 7 appears once in each of structures 2 and 4 of FIG. 6, respectively.

The output device 3 displays the set of characteristic structures shown in FIG. 7 sent from the output generation unit 25, to the user, as output at the current time (step A3 in FIG. 2). At this point in time, the user can perform interaction such as sending a part of the output at the current time to the additional processing execution unit 26.

On the other hand, the analysis order control unit 23 determines sequence in which the detailed text analysis unit 22 performs text analysis, according to order in which the text is stored in the text DB 11 similar to the simple text analysis unit 21, performing detailed analysis in the order of text 1, text 2, text 3, and text 4, of FIG. 5, (step A4 of FIG. 2).

The detailed text analysis unit 22 obtains the text 1 of FIG. 5 whose detailed analysis rank is indicated to have top priority by the analysis order control unit 23, from the text DB 11 (step A5 in FIG. 2).

The detailed text analysis unit 22 performs detailed analysis of the text 1 of FIG. 5 obtained from the text DB 11, obtains text structure, and substitutes with structure 1 (text structure of text 1 of FIG. 5 by the simple text analysis unit 21) of FIG. 6 stored in the analysis result holding unit 24 (step A6 of FIG. 2).

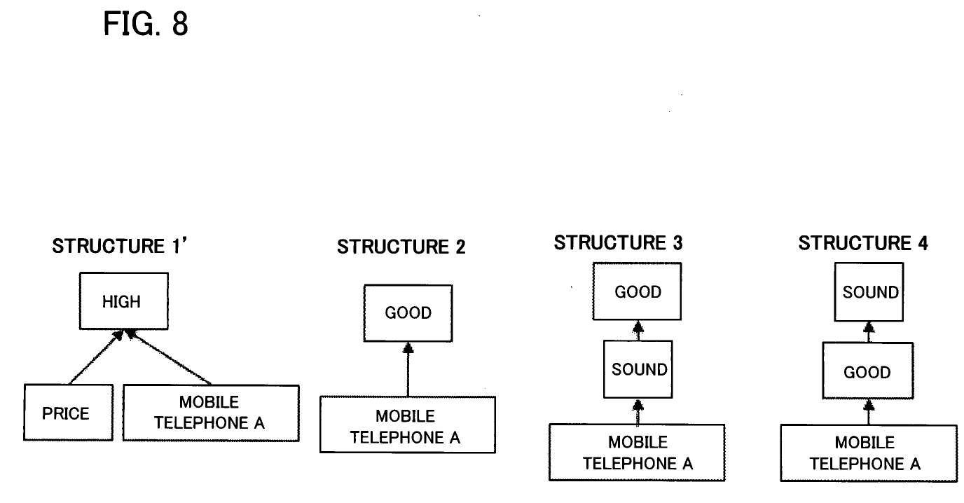

FIG. 8 is a drawing showing a set of text structures stored in the analysis result holding unit 24 at this time, for which replacement (switching) between the structure 1 of FIG. 6 and a structure 1′ that is the text structure of the text 1 of FIG. 5 by the detailed text analysis unit 22, has been performed.

Since timing of updating output of the output generation unit 25 is set to “perform updating of output whenever one text structure is sent from the detailed text analysis unit 22” as described above, if updating of the text structure stored in the analysis result holding unit 24 by the detailed text analysis unit 22 is performed, updating of output is performed immediately (Y in steps B1 and B2 of FIG. 3).

The output generation unit 25 extracts, as characteristic structures, part structures appearing two or more times, in the set of text structures shown in FIG. 8 updated in the analysis result holding unit 24, to be sent to the output device 3 (step B3 in FIG. 3).

Referring to FIG. 8, the extracted characteristic structures are as in the characteristic structures 1 to 4 of FIG. 7, and there is no change from a result of extracting characteristic structures from the set of text structures in FIG. 6. That is, the characteristic structure 1 “mobile telephone A” of FIG. 7 appears once in each of structure 1′ and structures 2 to 4 of FIG. 8, the characteristic structure 2 “good” of FIG. 7 appears once in each of structures 2 to 4 of FIG. 8, the characteristic structure 3 “sound” of FIG. 7 appears once in each of structures 3 and 4 of FIG. 8, and the characteristic structure 4 “mobile telephone A→good” of FIG. 7 appears once in each of structures 2 and 4 of FIG. 8, respectively.

The output device 3 displays the set of characteristic structures shown in FIG. 7 sent from the output generation unit 25, to the user, as output at the current time (step B4 in FIG. 3).

Since at this point in time analysis of all texts is not yet ended, analysis processing returns to step A4 of FIG. 2 and repeats (N in step A7 of FIG. 2).

In the present example, since the order of text analysis of the detailed text analysis unit 22 is according to the order in which the text DB 11 stores text, the order in which remaining text analysis is performed is not particularly changed. Accordingly, the analysis order control unit 23 determines performing detailed analysis in the order of text 2, text 3, and text 4 of FIG. 5 (step A4 of FIG. 2).

The detailed text analysis unit 22 obtains the text 2 of FIG. 5 whose detailed analysis rank is indicated to have top priority by the analysis order control unit 23, from the text DB 11 (step A5 in FIG. 2).

The detailed text analysis unit 22 performs detailed analysis of the text 2 of FIG. 5 obtained from the text DB 11, obtains text structure, and substitutes with structure 2 (text structure of text 2 of FIG. 5 by the simple text analysis unit 21) of FIG. 8 stored in the analysis result holding unit 24 (step A6 of FIG. 2).

However, since the text structure by the simple text analysis unit 21 with regard to the text 2 of FIG. 5, and the text structure by the detailed text analysis unit 22 are completely the same form (structure 2 of FIG. 8), even if replacement (switching) of structures is performed, the set of text structures is as shown in FIG. 8 and there is no change.

Since timing of updating output of the output generation unit 25 is set to “perform updating of output whenever one text structure is sent from the detailed text analysis unit 22” as described above, if updating of the text structure stored in the analysis result holding unit 24 by the detailed text analysis unit 22 is performed, updating of output is performed immediately (Y in steps B1 and B2 of FIG. 3).

The output generation unit 25 extracts, as characteristic structures, part structures appearing two or more times, in the set of text structures shown in FIG. 8 updated in the analysis result holding unit 24, to be sent to the output device 3 (step B3 in FIG. 3).

However, since the text structure by the simple text analysis unit 21 with regard to the text 2, and the text structure by the detailed text analysis unit 22 are completely the same form (structure 2 of FIG. 8), change does not occur in the abstracted result, and the abstracted characteristic structures are as in characteristic structures 1 to 4 of FIG. 7.

The output device 3 displays the set of characteristic structures shown in FIG. 7 sent from the output generation unit 25, to the user, as output at the current time (step B4 in FIG. 3).

Since at this point in time, analysis of all texts is not yet ended, analysis processing returns to step A4 of FIG. 2 and repeats (N in step A7 of FIG. 2).

In the present example, since the order of text analysis of the detailed text analysis unit 22 is according to the order in which the text DB 11 stores text, the order in which remaining text analysis is performed is not particularly changed. Accordingly, the analysis order control unit 23 determines performing detailed analysis in the order of text 3 and text 4 of FIG. 5 (step A4 of FIG. 2).

The detailed text analysis unit 22 obtains the text 3 of FIG. 5 whose detailed analysis rank is indicated to have top priority by the analysis order control unit 23, from the text DB 11 (step A5 in FIG. 2).

The detailed text analysis unit 22 performs detailed analysis of the text 3 of FIG. 5 obtained from the text DB 11, obtains text structure, and substitutes with structure 3 (text structure of text 3 of FIG. 5 by the simple text analysis unit 21) of FIG. 8 stored in the analysis result holding unit 24 (step A6 of FIG. 2).

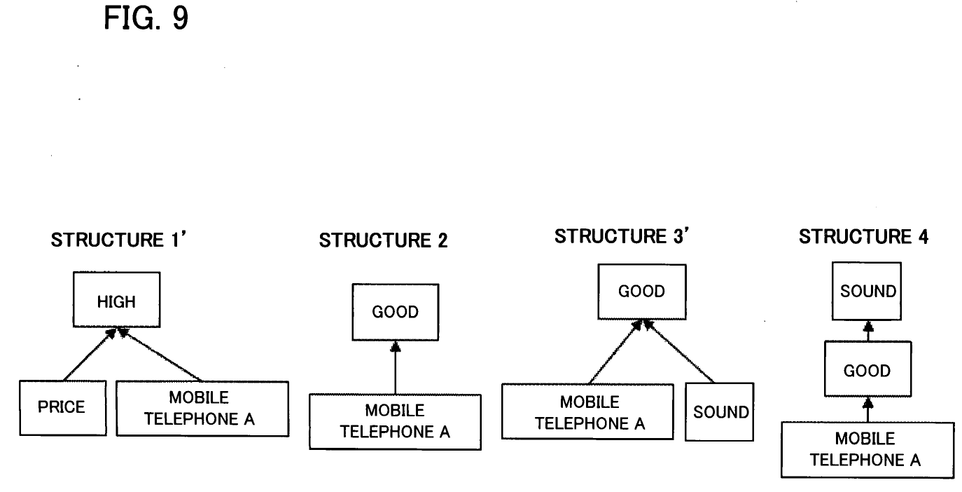

FIG. 9 is a drawing showing a set of text structures stored in the analysis result holding unit 24 at this time, for which replacement (switching) of the structure 3 of FIG. 8 with a structure 3′ that is the text structure of the text 3 of FIG. 5 by the detailed text analysis unit 22, has been performed.

Since timing of updating output of the output generation unit 25 is set to “perform updating of output whenever one text structure is sent from the detailed text analysis unit 22” as described above, if updating of the text structure stored in the analysis result holding unit 24 by the detailed text analysis unit 22 is performed, updating of output is performed immediately (Y in steps B1 and B2 of FIG. 3).

The output generation unit 25 extracts, as characteristic structures, part structures appearing two or more times, in the set of text structures shown in FIG. 9 updated in the analysis result holding unit 24, to be sent to the output device 3 (step B3 in FIG. 3).

Referring to FIG. 9, the extracted characteristic structures are as in the characteristic structures 1 to 4 of FIG. 7, and there is no change from the result of extracting the characteristic structures from the set of text structures in FIG. 6. That is, the characteristic structure 1 “mobile telephone A” of FIG. 7 appears once in each of structures 1′, 2, 3′ and 4 of FIG. 9, the characteristic structure 2 “good” of FIG. 7 appears once in each of structures 2, 3′, and 4 of FIG. 9, the characteristic structure 3 “sound” of FIG. 7 appears once in each of structures 3′ and 4 of FIG. 9, and the characteristic structure 4 “mobile telephone A→good” of FIG. 7 appears once in each of structures 2, 3′, and 4 of FIG. 9, respectively.

The output device 3 displays the set of characteristic structures shown in FIG. 7, sent from the output generation unit 25, to the user, as output at the current time (step B4 in FIG. 3).

Since at this point in time, analysis of all texts is not yet ended (completed), analysis processing returns to step A4 of FIG. 2 and repeats (N in step A7 of FIG. 2).

In the present example, since the order of text analysis of the detailed text analysis unit 22 is according to the order in which the text DB 11 stores texts, the order in which remaining text analysis is performed is not particularly changed. Accordingly, the analysis order control unit 23 determines performing detailed analysis of the text 4 of FIG. 5 (step A4 of FIG. 2).

The detailed text analysis unit 22 obtains the text 4 of FIG. 5 whose detailed analysis rank is indicated to have top priority by the analysis order control unit 23, from the text DB 11 (step A5 in FIG. 2).

The detailed text analysis unit 22 performs detailed analysis of the text 4 of FIG. 5 obtained from the text DB 11, obtains text structure, and substitutes with structure 4 (text structure of text 4 of FIG. 5 by the simple text analysis unit 24) of FIG. 9 stored in the analysis result holding unit 24 (step A6 of FIG. 2).

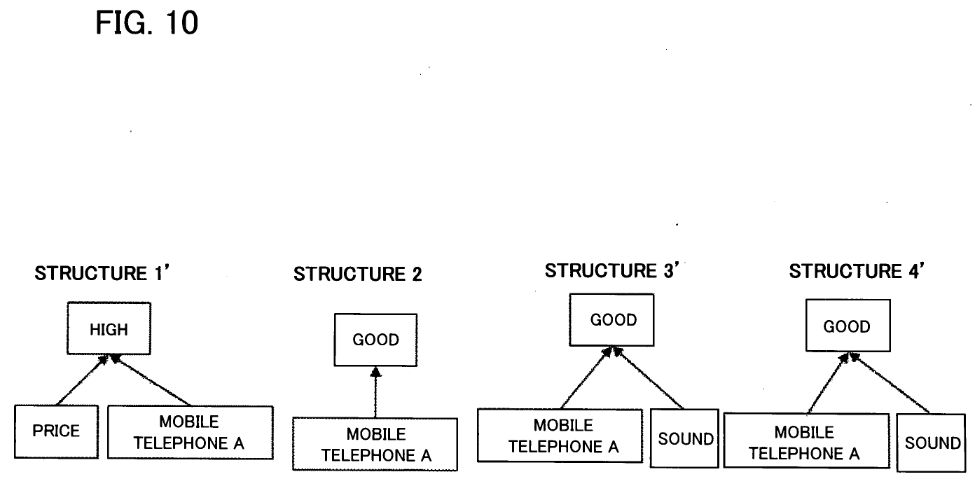

FIG. 10 is a drawing showing a set of text structures stored in the analysis result holding unit 24 at this point in time, for which switching of the structure 4 of FIG. 9 and a structure 4′ that is the text structure of the text 4 of FIG. 5 by the detailed text analysis unit 22, has been performed.

Since timing of updating output of the output generation unit 25 is set to “perform updating of output whenever one text structure is sent from the detailed text analysis unit 22” as described above, if updating of the text structure stored in the analysis result holding unit 24 by the detailed text analysis unit 22 is performed, updating of output is performed immediately (Y in steps B1 and B2 of FIG. 3).

The output generation unit 25 extracts, as characteristic structures, part structures appearing two or more times, in the set of text structures shown in FIG. 10 updated in the analysis result holding unit 24, to be sent to the output device 3 (step B3 in FIG. 3).

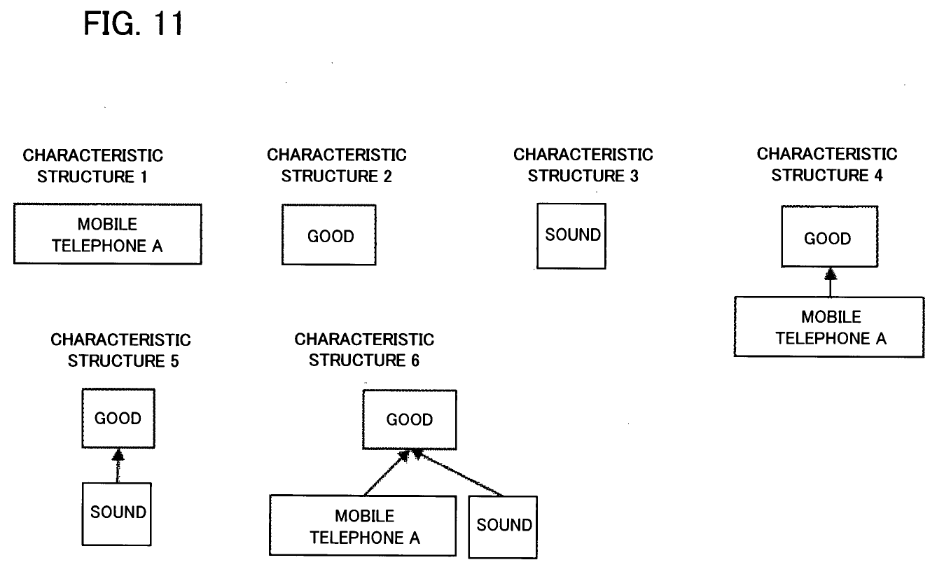

Referring to FIG. 10, the extracted characteristic structures are as in characteristic structures 1 to 6 of FIG. 11, and the characteristic structures 5 and 6 have been added to a result of extracting characteristic structures from the set of text structures of FIG. 6, FIG. 8, and FIG. 9, shown in FIG. 7. That is, the characteristic structure 1 “mobile telephone A” of FIG. 11 appears once in each of structures 1′, 2, 3′ and 4′ of FIG. 10, the characteristic structure 2 “good” of FIG. 11 appears once in each of structures 2, 3′, and 4′ of FIG. 10, the characteristic structure 3 “sound” of FIG. 11 appears once in each of structures 3′ and 4′ of FIG. 10, the characteristic structure 4 “mobile telephone A→good” of FIG. 11 appears once in each of structures 2, 3′, and 4′ of FIG. 10, the characteristic structure 5 “sound→good” of FIG. 11 appears once in each of structures 3′ and 4′ of FIG. 10, and the characteristic structure 6 “mobile telephone A→good←sound” of FIG. 11 appears once in each of structures 3′ and 4′ of FIG. 10, respectively.

The output device 3 displays the set of characteristic structures shown in FIG. 11, sent from the output generation unit 25, to the user, as output at the current time (step B4 in FIG. 3).

At this point in time, analysis of all the texts is ended (Y in step A7 of FIG. 2).

As described above, the present example has a configuration in which, without the user giving an explicit instruction, after the text analysis by the simple text analysis unit 21 has been ended, text analysis by the detailed text analysis unit 22 is immediately performed automatically, and in addition, it is possible to obtain the detailed analysis result automatically in the background while the user is performing interaction with the output by the simple text analysis.

Furthermore, since the present example is configured so that the output generation unit 25 automatically updates output every time one text is analyzed by the detailed text analysis unit 22, it is possible to present the best output at the present point in time without the user explicitly instructing updating.

### EXAMPLE 2

Continuing, a second example of the present invention will be described, referring to the drawings, in which an analysis order control unit 23 dynamically changes analysis order of a detailed text analysis unit 22. A language processing system according to the second example of the present invention, similar to the abovementioned first exemplary embodiment of the invention, is configured by being provided with a personal computer constituting a data processing device 2 of FIG. 1, a magnetic disk storage device constituting a storage device 1, a display device constituting an output device 3, and a keyboard constituting an input device 4.

The personal computer has a simple text analysis unit 21, a detailed text analysis unit 22, an analysis order control unit 23, a central processing unit (CPU) functioning as an output generation unit 25, and a memory functioning as an analysis result holding unit 24. A text set shown in FIG. 5 similar to the abovementioned first example is stored as text DB 11 in the magnetic disk storage device.

The analysis order control unit 23 in the present example, differing from the first example, uses an extraction result of characteristic structures by the output generation unit 25 that uses text structures outputted by the simple text analysis unit 21, and determines order of analysis by the detailed text analysis unit 22 such that detailed analysis is performed first from a text including more characteristic structures.

Otherwise, since the simple text analysis unit 21, the detailed text analysis unit 22, the analysis result holding unit 24, and the output generation unit 25 are similar to the abovementioned first example, descriptions will be omitted.

First, the simple text analysis unit 21 performs language analysis on each text in the text set in the text DB 11 shown in FIG. 5, and obtains a text structure of each text, to be sent to the analysis result holding unit 24 (step A1 in FIG. 2).

At this point in time, similar to the first example, the text structures stored in the analysis result holding unit 24 are as in FIG. 6. That is, a text structure of text 1 of FIG. 5 corresponds to structure 1 of FIG. 6, a text structure of text 2 of FIG. 5 corresponds to structure 2 of FIG. 6, a text structure of text 3 of FIG. 5 corresponds to structure 3 of FIG. 6, and a text structure of text 4 of FIG. 5 corresponds to structure 4 of FIG. 6, respectively.

The output generation unit 25 extracts, as characteristic structures, part structures appearing two or more times, in the text structure set according to the simple text analysis unit 21 shown in FIG. 6, and stored in the analysis result holding unit 24, to be sent to the output device 3 (step A2 in FIG. 2).

At this point in time, the extracted characteristic structures are similar to the abovementioned first example, and are as in FIG. 7. That is, a characteristic structure 1 “mobile telephone A” of FIG. 7 appears once in each of structures 1 to 4 of FIG. 6, a characteristic structure 2 “good” of FIG. 7 appears once in each of structures 2 to 4 of FIG. 6, a characteristic structure 3 “sound” of FIG. 7 appears once in each of structures 3 and 4 of FIG. 6, and a characteristic structure 4 “mobile telephone A→good” of FIG. 7 appears once in each of structures 2 and 4 of FIG. 6, respectively.

The output device 3 displays the set of characteristic structures shown in FIG. 7 sent from the output generation unit 25, to the user, as output at the current time (step A3 in FIG. 2). At this point in time, the user can perform interaction such as sending a part of the output at the current time to the additional processing execution unit 26.

On the other hand, the analysis order control unit 23, based on results of extracting characteristic structures by the output generation unit 25 that uses text structures by the simple text analysis unit 21 shown in FIG. 7, determines order of analysis by the detailed text analysis unit 22 such that detailed analysis is performed first from a text including more (i.e., a larger number of) characteristic structures (step A4 of FIG. 2).

Referring to FIG. 6 and FIG. 7, since the structure 1 of FIG. 6 includes one (characteristic structure 1) among the characteristic structures of FIG. 7, the structure 2 of FIG. 6 includes 3 (characteristic structures 1, 2, and 4) among the characteristic structures of FIG. 7, the structure 3 of FIG. 6 includes 3 (characteristic structures 1 to 3) among the characteristic structures of FIG. 7, and the structure 4 of FIG. 6 includes 4 (characteristic structures 1 to 4) among the characteristic structures of FIG. 7, the analysis order control unit 23 determines performing of analysis by the detailed text analysis unit 22 in the order of text 4 (characteristic structure=4), text 2 (characteristic structure=3), text 3 (characteristic structure=3), and text 1 (characteristic structure=1) of FIG. 5.

The detailed text analysis unit 22 obtains the text 4 of FIG. 5 whose detailed analysis rank is indicated to have top priority by the analysis order control unit 23, from the text DB 11 (step A5 in FIG. 2).

The detailed text analysis unit 22 performs detailed analysis of the text 4 of FIG. 5 obtained from the text DB 11, obtains text structure, which is substituted with structure 4 (text structure of text 4 of FIG. 5 by the simple text analysis unit 21) of FIG. 6 stored in the analysis result holding unit 24 (step A6 of FIG. 2).

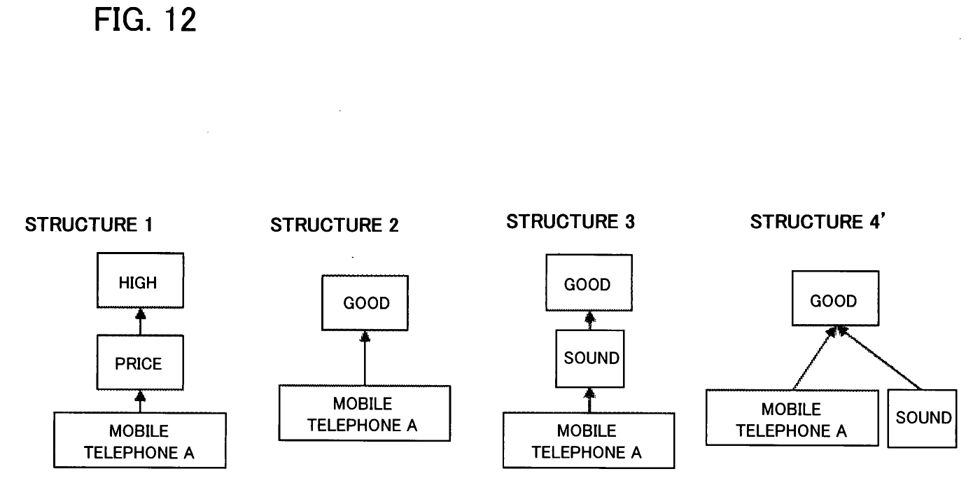

FIG. 12 is a drawing showing a set of text structures stored in the analysis result holding unit 24 at this point in time, for which replacement (switching) of the structure 1 of FIG. 6 with a structure 4′ that is the text structure of the text 4 of FIG. 5 by the detailed text analysis unit 22, has been performed.

Since timing of updating output of the output generation unit 25 is set so as to “perform updating of output whenever one text structure is sent from the detailed text analysis unit 22” similarly to the first example, if updating of the text structure stored in the analysis result holding unit 24 by the detailed text analysis unit 22 is performed, updating of output is performed immediately (Y in steps B1 and B2 of FIG. 3).

The output generation unit 25 extracts, as characteristic structures, part structures appearing two or more times, in the set of text structures shown in FIG. 12 updated in the analysis result holding unit 24, to be sent to the output device 3 (step B3 in FIG. 3).

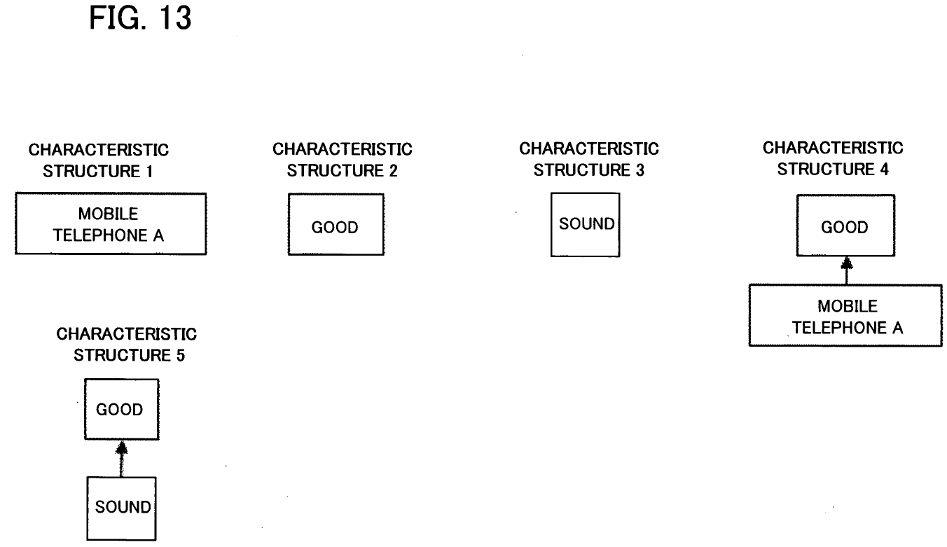

Referring to FIG. 12, the extracted characteristic structures are as in the characteristic structures 1 to 5 of FIG. 13, and the characteristic structure 5 has been added to a result of extracting characteristic structures from the set of text structures of FIG. 6, shown in FIG. 7. That is, a characteristic structure 1 “mobile telephone A” of FIG. 13 appears once in each of structures 1, 2, 3, and 4′ of FIG. 12, a characteristic structure 2 “good” of FIG. 13 appears once in each of structures 2, 3, and 4′ of FIG. 12, a characteristic structure 3 “sound” of FIG. 13 appears once in each of structures 3′ and 4′ of FIG. 12, a characteristic structure 4 “mobile telephone A→good” of FIG. 13 appears once in each of structures 2 and 4′ of FIG. 12, and a characteristic structure 5 “sound→good” of FIG. 13 appears once in each of structures 3 and 4′ of FIG. 12, respectively

The output device 3 displays the set of characteristic structures shown in FIG. 13, sent from the output generation unit 25, to the user, as output at the current time (step B4 in FIG. 3).

Since at this point in time, analysis of all texts is not yet ended, analysis processing returns to step A4 of FIG. 2 and repeats (N in step A7 of FIG. 2).

In the present example, since the analysis order control unit 23 does not particularly change the order in which the detailed text analysis unit 22 performs remaining text analysis, the analysis order control unit 23 then determines performance of the detailed analysis in the order of text 2 (characteristic structure=3), text 3 (characteristic structure=3), and text 1 (characteristic structure=1) of FIG. 5 (step A4 of FIG. 2).

The detailed text analysis unit 22 obtains the text 2 of FIG. 5 whose detailed analysis rank is indicated to have top priority by the analysis order control unit 23, from the text DB 11 (step A5 in FIG. 2).

The detailed text analysis unit 22 performs detailed analysis of the text 2 of FIG. 5 obtained from the text DB 11, obtains text structure, which is substituted with structure 2 (text structure of text 2 of FIG. 5 by the simple text analysis unit 21) of FIG. 12 stored in the analysis result holding unit 24 (step A6 of FIG. 2).

However, since the text structure by the simple text analysis unit 21 with regard to the text 2 of FIG. 5, and the text structure by the detailed text analysis unit 22 are completely the same form (structure 2 of FIG. 12), even if replacement (switching) of structures is performed, the set of text structures is as shown in FIG. 12 and there is no change.

Since timing of updating output of the output generation unit 25 is set so as to “perform updating of output whenever one text structure is sent from the detailed text analysis unit 22” similarly to the first example, if updating of the text structure stored in the analysis result holding unit 24 by the detailed text analysis unit 22 is performed, updating of output is performed immediately (Y in steps B1 and B2 of FIG. 3).

The output generation unit 25 extracts, as characteristic structures, part structures appearing two or more times in the set of text structures shown in FIG. 12 updated in the analysis result holding unit 24, to be sent to the output device 3 (step B3 in FIG. 3).

However, since the text structure by the simple text analysis unit 21 of the text 2, and the text structure by the detailed text analysis unit 22 are completely the same form (structure 2 of FIG. 12), no change occurs in the extracted result, and the extracted characteristic structures are as in the characteristic structures 1 to 5 of FIG. 13.

The output device 3 displays the set of characteristic structures shown in FIG. 13, sent from the output generation unit 25, to the user, as output at the current time (step B4 in FIG. 3).

Since at this point in time, analysis of all texts is not yet ended, analysis processing returns to step A4 of FIG. 2 and repeats (N in step A7 of FIG. 2).

In the present example, since the analysis order control unit 23 does not particularly change the order in which the detailed text analysis unit 22 performs remaining text analysis, the analysis order control unit 23 then determines performance of the detailed analysis in the order of text 3 (characteristic structure=3) and text 1 (characteristic structure=1) of FIG. 5 (step A4 of FIG. 2).

The detailed text analysis unit 22 obtains the text 3 of FIG. 5 whose detailed analysis rank is indicated to have top priority by the analysis order control unit 23, from the text DB 11 (step A5 in FIG. 2).

The detailed text analysis unit 22 performs detailed analysis of the text 3 of FIG. 5 obtained from the text DB 11, obtains text structure, which is substituted with structure 3 (text structure of text 3 of FIG. 5 by the simple text analysis unit 21) of FIG. 12 stored in the analysis result holding unit 24 (step A6 of FIG. 2).

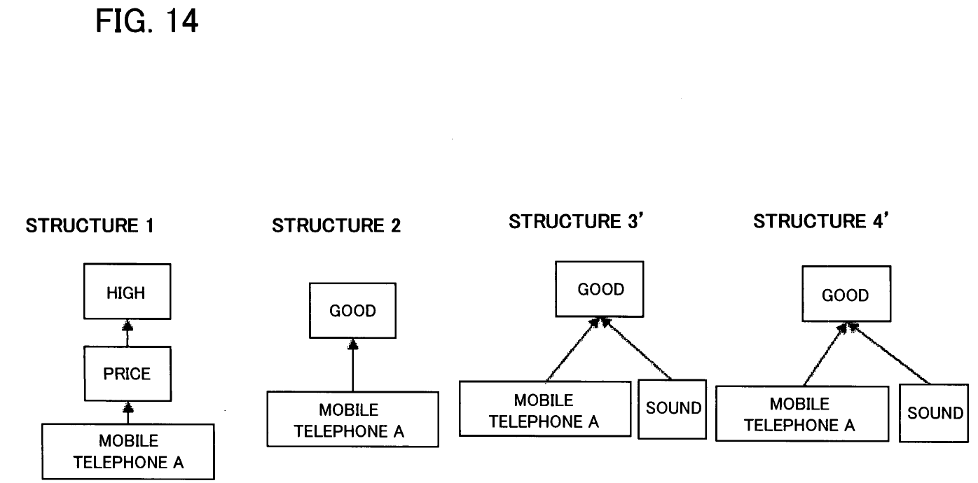

FIG. 14 is a drawing showing a set of text structures stored in the analysis result holding unit 24 at this time, for which replacement (switching) of the structure 3 of FIG. 12 and a structure 3′ that is the text structure of the text 3 of FIG. 5 by the detailed text analysis unit 22, has been performed.

Since timing of updating output of the output generation unit 25 is set so as to “perform updating of output whenever one text structure is sent from the detailed text analysis unit 22” similarly to the first example, if updating of the text structure stored in the analysis result holding unit 24 by the detailed text analysis unit 22 is performed, updating of output is performed immediately (Y in steps B1 and B2 of FIG. 3).

The output generation unit 25 extracts, as characteristic structures, part structures appearing two or more times, in the set of text structures shown in FIG. 14 updated in the analysis result holding unit 24, to be sent to the output device 3 (step B3 in FIG. 3).

Referring to FIG. 14, the extracted characteristic structures are as in the characteristic structures 1 to 6 of FIG. 11, and the characteristic structure 6 has been added to a result of extracting characteristic structures from the set of text structures of FIG. 12, shown in FIG. 13. That is, the characteristic structure 1 “mobile telephone A” of FIG. 11 appears once in each of structures 1, 2, 3′, and 4′ of FIG. 14, the characteristic structure 2 “good” of FIG. 11 appears once in each of structures 2, 3′, and 4′ of FIG. 14, the characteristic structure 3 “sound” of FIG. 11 appears once in each of structures 3′ and 4′ of FIG. 14, the characteristic structure 4 “mobile telephone A→good” of FIG. 11 appears once in each of structures 2, 3′, and 4′ of FIG. 14, the characteristic structure 5 “sound→good” of FIG. 11 appears once in each of structures 3′ and 4′ of FIG. 14, and the characteristic structure 6 “mobile telephone A→good←sound” of FIG. 11 appears once in each of structures 3′ and 4′ of FIG. 14, respectively.

The output device 3 displays the set of characteristic structures shown in FIG. 11, sent from the output generation unit 25, to the user, as output at the current time (step B4 in FIG. 3).

Since at this point in time, analysis of all texts is not yet ended, analysis processing returns to step A4 of FIG. 2 and repeats (N in step A7 of FIG. 2).

In the present example, since the analysis order control unit 23 does not particularly change the order in which the detailed text analysis unit 22 performs remaining text analysis, the analysis order control unit 23 then determines performance of the detailed analysis of text 1 (characteristic structure=1) of FIG. 5 (step A4 of FIG. 2).

The detailed text analysis unit 22 obtains the text 1 of FIG. 5 whose detailed analysis rank is indicated to have top priority by the analysis order control unit 23, from the text DB 11 (step A5 in FIG. 2).

The detailed text analysis unit 22 performs detailed analysis of the text 1 of FIG. 5 obtained from the text DB 11, obtains text structure, which is substituted with structure 1 (text structure of text 1 of FIG. 5 by the simple text analysis unit 21) of FIG. 12 stored in the analysis result holding unit 24 (step A6 of FIG. 2).

FIG. 10 is a drawing showing a set of text structures stored in the analysis result holding unit 24 at this time, for which replacement (switching) of the structure 1 of FIG. 12 with a structure 1′ that is the text structure of the text 1 of FIG. 5 by the detailed text analysis unit 22, has been performed.

Since timing of updating output of the output generation unit 25 is set so as to “perform updating of output whenever one text structure is sent from the detailed text analysis unit 22” similarly to the first example, if updating of the text structure stored in the analysis result holding unit 24 by the detailed text analysis unit 22 is performed, updating of output is performed immediately (Y in steps B1 and B2 of FIG. 3).

The output generation unit 25 extracts, as characteristic structures, part structures appearing two or more times in the set of text structures shown in FIG. 10 updated in the analysis result holding unit 24, to be sent to the output device 3 (step B3 in FIG. 3).

Referring to FIG. 10, the extracted characteristic structures are as in the characteristic structures 1 to 6 of FIG. 11, and there is no change from a result of extracting characteristic structures from the set of text structures in FIG. 14. That is, the characteristic structure 1 “mobile telephone A” of FIG. 11 appears once in each of structures 1′, 2, 3′, and 4′ of FIG. 10, the characteristic structure 2 “good” of FIG. 11 appears once in each of structures 2, 3′, and 4′ of FIG. 10, the characteristic structure 3 “sound” of FIG. 11 appears once in each of structures 3′ and 4′ of FIG. 10, the characteristic structure 4 “mobile telephone A→good” of FIG. 11 appears once in each of structures 2, 3′, and 4′ of FIG. 10, the characteristic structure 5 “sound→good” of FIG. 11 appears once in each of structures 3′ and 4′ of FIG. 10, and the characteristic structure 6 “mobile telephone A→good←sound” of FIG. 11 appears once in each of structures 3′ and 4′ of FIG. 10, respectively.

The output device 3 displays the set of characteristic structures shown in FIG. 11, sent from the output generation unit 25, to the user, as output at the current time (step B4 in FIG. 3).

At this point in time, analysis of all the texts is ended (Y in step A7 of FIG. 2).

As described above, for characteristic structures 5 and 6 that could not be obtained without analyzing four texts by the detailed text analysis unit 23 in the first example, it is possible in the present example to obtain the characteristic structure 5 at a point in time when one text has been analyzed by the detailed text analysis unit 23, and the characteristic structure 6 at a point in time when three texts have been analyzed by the detailed text analysis unit 23.

The reason for this is that in the present example, control is done by the analysis order control unit 23 so as to analyze by the detailed text analysis unit 22 from a text including a larger number of output based on the simple text analysis unit 21, and it is possible to present important output quicker to the user.

Furthermore, in each of the above described examples, order of text for which detailed text analysis is to be performed is determined by storage order in the text DB 11 and importance computed by the output generation unit 25, but otherwise, as mentioned above, order of text for which the abovementioned detailed text analysis is to be performed may be determined: (A1) randomly, (A2) according to an attribute value given in advance to the text, (A4) a score based on interaction with (simple text analysis) output by the user, or the like. For example, if done as in (A4), at a point in time when detailed analysis of only a portion the user is focused on is ended, it is possible to use a result thereof.

Furthermore, in the abovementioned examples, to constantly provide the latest information to the user, whenever detailed analysis of one text ends, analysis results are automatically updated, but it is also possible to make the output generation unit 25 operate at various types of timing shown in previously exemplified (B2) to (B5).

Exemplary embodiments and examples for implementing the present invention have been described above but the technological scope of the invention is not limited to the abovementioned exemplary embodiments and examples. For example, the present invention can be preferably applied to a language processing system (text mining device) for performing analysis (characteristic analysis) of various types of text such as mail complaints or questionnaire results from customers, and clearly it is possible to add various modifications in accordance with specifications and the like, of text (language) to be analyzed, or the computer composing the language processing system (text mining device).

Modifications and adjustments of the exemplary embodiments and examples are possible within the entire disclosure (including the scope of the claims) of the present invention, and in addition, based on fundamental technological ideas thereof. Furthermore, various types of combinations and selections of various disclosed elements are possible within the scope of the claims of the present invention.

1. A language processor comprising:
a plurality of text analysis units, each performing a different type of text analysis processing;
an analysis order control unit for controlling order of analysis of a plurality of input texts by each of said text analysis units; and
an additional processing execution unit for taking text analysis results of said plurality of input texts from said text analysis units, and for receiving and executing additional processing from a user, with regard to said text analysis results; wherein
at a stage at which a text analysis result by any one of said text analysis units is outputted and said additional processing execution unit operates, said analysis order control unit performs control to start text analysis processing for other text analysis units.

2. The language processor according to claim 1 wherein
said analysis order control unit determines analysis order of each of said input texts, based on an attribute value held by each of said input texts.

3. The language processor according to claim 1 wherein
said analysis order control unit determines analysis order of each of said input texts, based on text length of each of said input texts.

4. The language processor according to claim 1 wherein
said analysis order control unit changes order of analysis, based on a text analysis result from any one of said text analysis units, of each of said input texts by another of said text analysis units.

5. The language processor according to claim 1, further comprising
an output generation unit for computing the number of structures (characteristic structures) appearing commonly in each of said input texts included in each of said input texts, based on text analysis results from each of said text analysis units; wherein
said analysis order control unit changes analysis order of each of said input texts, so as to give priority to analysis of an input text according to a larger number of said structures (characteristic structures) appearing commonly in each of said input texts.

6. The language processor according to claim 1, wherein
said analysis order control unit changes analysis order of each of said input texts, so as to give priority to analysis of an input text including a structure (characteristic structure) received from a user, among structures (characteristic structures) appearing commonly in each of said input texts.

7. The language processor according to claim 1, wherein
computational amounts of text analysis processing by each of said text analysis units are each different, and
said analysis order control unit operates by giving priority to a text analysis unit performing text analysis processing of small computational amount.

8. The language processor according to claim 1, further comprising:
a simple text analysis unit for executing text analysis processing not using parsing, and a detailed text analysis unit for executing text analysis processing using parsing, as said text analysis units.

9. The language processor according to claim 1, further comprising:
a text mining processing means for performing text mining processing, as said additional processing execution unit.

10. A language processing method for a language processor for analyzing text, said processor including:
a plurality of text analysis units, each performing a different type of text analysis processing;
an analysis order control unit for controlling order of analysis of a plurality of input texts by each of said text analysis units; and
an additional processing execution unit for taking text analysis results of said plurality of input texts from said text analysis units, and for receiving and executing additional processing from a user, with regard to said text analysis results; wherein
said method comprises:
a step in which said additional processing execution unit starts dialogue with the user with regard to additional processing for a text analysis result outputted by any one of said text analysis units; and
a step in which said analysis order control unit starts text analysis processing by another text analysis unit, in the background to dialogue processing between said user and said additional processing execution unit.

11. The language processing method according to claim 10, further comprising:
a step in which said analysis order control unit determines analysis order of each of said input texts, based on an attribute value held by each of said input texts.

12. The language processing method according to claim 10, further comprising:
a step in which said analysis order control unit determines analysis order of each of said input texts, based on text length of each of said input texts.

13. The language processing method according to claim 10, further comprising:
a step in which said analysis order control unit changes order of analysis, based on a text analysis result from any one of said text analysis units, of each of said input texts by another of said text analysis units.

14. The language processing method according to claim 10, further comprising:
a step in which an output generation unit provided in said language processor computes the number of structures (characteristic structures) appearing commonly in each of said input texts included in each of said input texts, based on text analysis results from each of said text analysis units; and
a step in which said analysis order control unit changes analysis order of each of said input texts, so as to give priority to analysis of an input text according to a larger number of said structures (characteristic structures) appearing commonly in each of said input texts.

15. The language processing method according to claim 10, further comprising:
a step in which said analysis order control unit changes analysis order of each of said input texts so as to give priority to analysis of an input text including a structure (characteristic structure) received from a user, among structures (characteristic structures) appearing commonly in each of said input texts.

16. The language processing method according to claim 10, wherein
computational amounts of text analysis processing by each of said text analysis units are each different, and
said analysis order control unit operates by giving priority to a text analysis unit performing text analysis processing of small computational amount.

17. The language processing method according to claim 10, wherein
said analysis order control unit first operates a simple text analysis unit for executing text analysis processing not using parsing, and at a stage at which said additional processing execution unit starts dialogue with the user concerning an analysis result of said simple text analysis unit, operates a detailed text analysis unit for executing text analysis processing using parsing.

18. The language processing method according to claim 10, wherein
said additional processing execution unit, being a text mining processing means for performing text mining processing, receives a text mining condition, with regard to a text analysis result from each of said text analysis units, to execute text mining.

19. A language processing program for controlling a computer and analyzing text, said computer including:
a plurality of text analysis units, each performing a different type of text analysis processing;
an analysis order control unit for controlling order of analysis of a plurality of input texts by each of said text analysis units; and
an additional processing execution unit for taking text analysis results of said plurality of input texts from said text analysis units, and for receiving and executing additional processing from a user, with regard to said text analysis results; wherein
said program causes said computer to execute:
a process of starting dialogue with the user, with regard to additional processing for a text analysis result outputted by any one of said text analysis units; and
a process of starting text analysis processing in another text analysis unit, in the background to dialogue processing between said user and said additional processing execution unit.

20. The language processing program according to claim 19 wherein
said program causes said analysis order control unit to determine analysis order of each of said input texts, based on an attribute value held by each of said input texts.

21. The language processing program according to claim 19 wherein
said program causes said analysis order control unit to determine analysis order of each of said input texts, based on text length of each of said input texts.

22. The language processing program according to claim 19, wherein
said program causes said analysis order control unit to change order of analysis, based on a text analysis result from any one of said text analysis units, of each of said input texts by another of said text analysis units.

23. The language processing program according to claim 19, further comprising:
a process in which an output generation unit provided in said computer is made to compute the number of structures (characteristic structures) appearing commonly in each of said input texts included in each of said input texts, based on text analysis results from each of said text analysis units; and wherein
said program causes said analysis order control unit to change changes analysis order of each of said input texts, so as to give priority to analysis of an input text according to a larger number of said structures (characteristic structures) appearing commonly in each of said input texts.

24. The language processing program according to claim 19, wherein
said program causes said analysis order control unit to change changes analysis order of each of said input texts, so as to give priority to analysis of an input text including a structure (characteristic structure) received from a user, among structures (characteristic structures) appearing commonly in each of said input texts.

25. The language processing program according to claim 19 wherein
computational amounts of text analysis processing by each of said text analysis units are each different, and
said program causes said analysis order control unit to operate by giving priority to a text analysis unit performing text analysis processing of a smaller computational amount.

26. The language processing program according to claim 19, wherein
said program causes said analysis order control unit to operate a simple text analysis unit for executing text analysis processing not using parsing, and then said program causes said additional processing execution unit to start dialogue with the user concerning an analysis result of said simple text analysis unit, to operate a detailed text analysis unit for executing text analysis processing using parsing.

27. The language processing program according to claim 19, wherein
said program causes said additional processing execution unit, being a text mining processing means for performing text mining processing, to receive a text mining condition, with regard to a text analysis result from each of said text analysis units, to execute text mining.
